(19) United States
(12) Patent Application Publication
(10) Pub. No.: US 2014/0136655 A1
(43) Pub. Date: May 15, 2014

(54) COMMUNICATION APPARATUS, COMMUNICATION METHOD, AND COMPUTER READABLE MEDIUM

(71) Applicant: FUJI XEROX CO., LTD., TOKYO (JP)

(72) Inventor: Akihide OSHIMA, Kanagawa (JP)

(21) Appl. No.: 13/909,360

(22) Filed: Jun. 4, 2013

(30) Foreign Application Priority Data
Nov. 15, 2012 (JP) 2012-251286

(51) Int. Cl. H04L 29/08

(52) U.S. Cl. CPC H04L 67/02
USPC 709/217

(57) ABSTRACT

A communication apparatus includes plural communication interfaces, an associating section, and a transmitting section. The associating section associates issued certificate information with one of the plural communication interfaces. The transmitting section transmits the certificate information from the communication interface with which the certificate information is associated. The associating section includes an identification information acquiring unit and a determining unit. The identification information acquiring unit acquires identification information in a network of each of the plural communication interfaces. The determining unit determines a communication interface to be associated, in accordance with the identification information acquired by the identification information acquiring unit.

### CROSS-REFERENCE TO RELATED APPLICATIONS

This application is based on and claims priority under 35 USC 119 from Japanese Patent Application No. 2012-251286 filed Nov. 15, 2012.

### BACKGROUND

### Technical Field

The present invention relates to a communication apparatus, a communication method, and a computer readable medium.

### SUMMARY

According to an aspect of the invention, there is provided a communication apparatus including plural communication interfaces, an associating section, and a transmitting section. The associating section associates issued certificate information with one of the plural communication interfaces. The transmitting section transmits the certificate information from the communication interface with which the certificate information is associated. The associating section includes an identification information acquiring unit and a determining unit. The identification information acquiring unit acquires identification information in a network of each of the plural communication interfaces. The determining unit determines a communication interface to be associated, in accordance with the identification information acquired by the identification information acquiring unit.

### BRIEF DESCRIPTION OF THE DRAWINGS

Exemplary embodiment of the present invention will be described in detail based on the following figures, wherein:

FIG. 1 is a diagram illustrating an example of the configuration of an image forming apparatus;

FIG. 2 is a diagram illustrating an example of the contents described in a certificate;

FIG. 3 is a diagram illustrating an example of an IF management table;

FIG. 4 is a diagram illustrating an example of a process performed by the image forming apparatus;

FIG. 5A is a diagram illustrating an example of a certificate management table; and

FIG. 5B is a diagram illustrating an example of a certificate management table.

### DETAILED DESCRIPTION

Hereinafter, exemplary embodiments of the present invention will be described in detail with reference to the drawings.

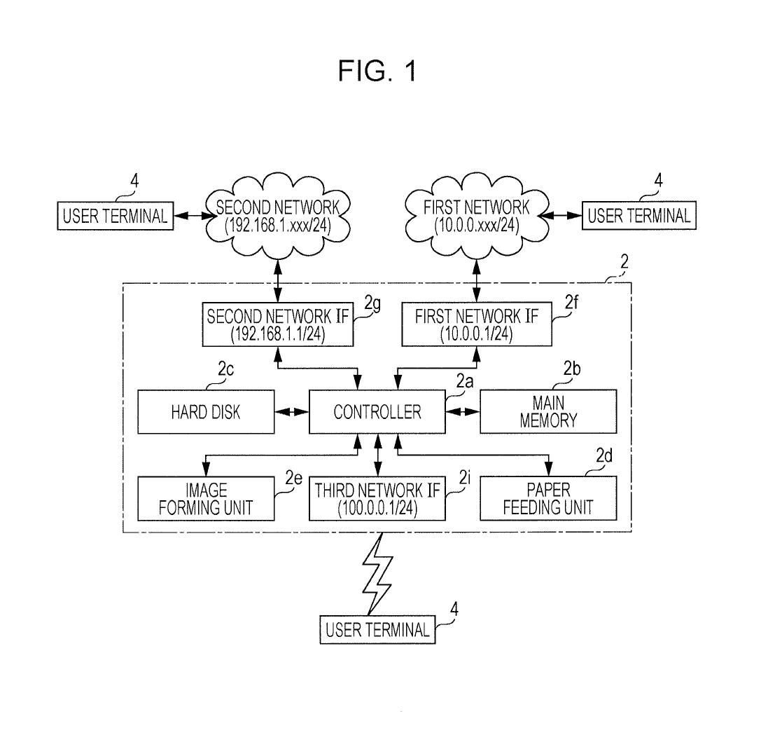

FIG. 1 illustrates an example of the configuration of an image forming apparatus (communication apparatus) 2 according to an exemplary embodiment of the present invention. In this exemplary embodiment, the image forming apparatus 2 is implemented as a computer (so-called multi-functioned machine) having a printing function, a scanning function, a FAX communication function, and the like and is installed at an office of a company X. As illustrated in FIG. 1, the image forming apparatus 2 includes a controller 2a, which is implemented by a microprocessor. The controller 2a performs various types of information processing and controls other component parts in accordance with a program stored in a main memory 2b, which will be described later. The image forming apparatus 2 also includes the main memory 2b, which is implemented by a read only memory (ROM) and a random access memory (RAM). Data to be used in the process of information processing by the controller 2a is stored in the main memory 2b. The above-mentioned program is also stored in the main memory 2b. The program may be read from a computer-readable information storage medium, such as a digital versatile disc (DVD) (registered trademark)-ROM or the like, and stored into the main memory 2b. Alternatively, the program may be downloaded via a network and stored into the main memory 2b.

The image forming apparatus 2 also includes a hard disk 2c. Various data are stored in the hard disk 2c. Three (public-key) certificates issued by a certificate authority, that is, a certificate A, a certificate B, and a certificate C, are stored in the hard disk 2c. These certificates are imported and stored in the hard disk 2c.

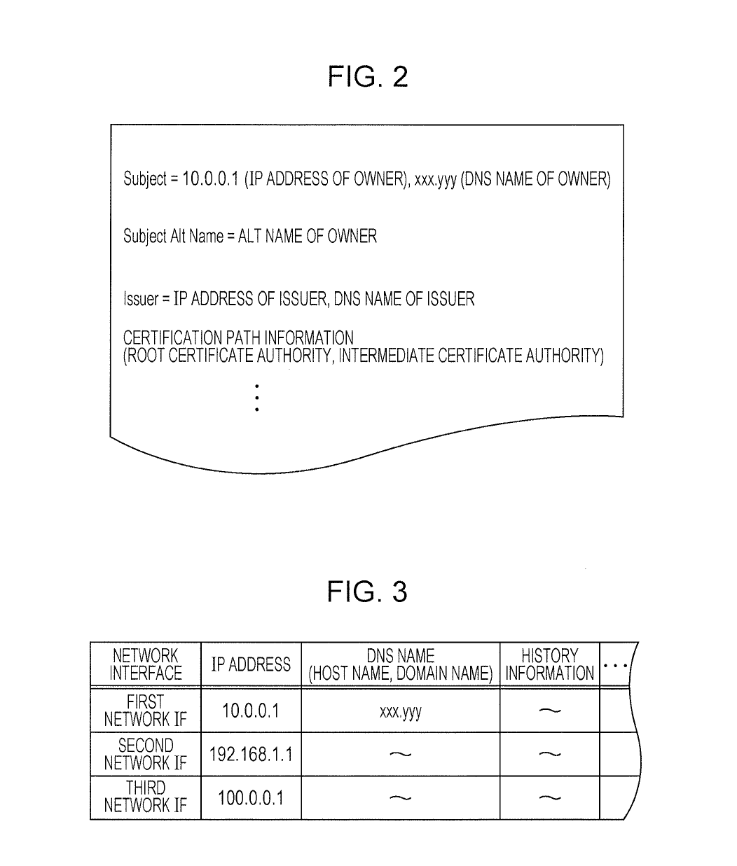

FIG. 2 illustrates an example of the contents described in a certificate (here, the certificate A). The certificate includes identification information “Subject” in an owner's network. In “Subject”, at least one of the IP address and domain name system (DNS) name of the owner is described. The DNS name includes a host name and a domain name. The certificate also includes an alt name of the owner “Subject Alt Name”. The certificate also includes identification information of an issuer “Issuer”. In “Issuer”, at least one of the IP address and DNS name of the issuer is described. The certificate also includes certification path information representing a certification path. The certification path information includes data representing a root certificate authority and an intermediate certificate authority. The certification path is also called a certificate chain.

Other information stored in the hard disk 2c will be described later.

The image forming apparatus 2 also includes a paper feeding unit 2d and an image forming unit 2e. The paper feeding unit 2d feeds printing paper stored in a paper storing unit, which is not illustrated, to the image forming unit 2e, in accordance with an instruction by the controller 2a. The image forming unit 2e is, for example, a laser printer. The image forming unit 2e prints images on printing paper fed by the paper feeding unit 2d, in accordance with an instruction from the controller 2a. The image forming apparatus 2 also includes a display that outputs information supplied from the controller 2a, an operation input unit (for example, a touch panel and various buttons) that supplies an operation signal representing the details of an operation performed by a user to the controller 2a, and the like.

Furthermore, as illustrated in FIG. 1, the image forming apparatus 2 includes plural communication interfaces, that is, a first network interface (hereinafter, noted as a first network IF) 2f, a second network interface (hereinafter, noted as a second network IF) 2g, and a third network interface (hereinafter, noted as a third network IF) 2i. The first network IF 2f is a communication interface for connecting the image forming apparatus 2 to a first network, which is an intranet of the company X and is represented by an IP address “10.0.0.1/24” (“/24” means that subnet mask is upper 24 bit). A user terminal 4 of a user is connected to the first network. Furthermore, in terms of security, a quarantine server, an account management server, a Kerberos authentication server, and the like, which are not illustrated, are connected to the first network.

The second network IF 2g is a communication interface for connecting the image forming apparatus 2 to a second network, which is connected to the Internet via firewall, which is not illustrated, and is represented by an IP address “192.168.1.1/24”. A user terminal 4 of a user is also connected to the second network.

The third network IF 2i is a communication interface for peer-to-peer connecting the image forming apparatus 2 to a user terminal 4 of a user using wireless communication, such as Bluetooth (registered trademark) communication, WiFi-Direct communication, or the like.

In this exemplary embodiment, an IF management table illustrated in FIG. 3 is stored in the hard disk 2c. Network settings for individual network interfaces, that is, IP addresses and DNS addresses of the individual network interfaces, are stored in the IF management table. In this exemplary embodiment, as illustrated in FIGS. 1 and 3, the IP address of the first network IF 2f is “10.0.0.1”, the IP address of the second network IF 2g is “192.168.1.1”, and the IP address of the third network IF 2i is “100.0.0.1”.

In the IF management table, history information relating to history of communication performed by the individual network interfaces is also stored. The history information will be described later.

With the use of the user terminal 4 owned by a user, the user transmits a request for execution of printing or a request for execution of scanning to the image forming apparatus 2 and uses a web service provided by the image forming apparatus 2. The user sets the value of an operation setting parameter for the image forming apparatus 2, for example, using the web service.

Here, at the time of communication, in terms of security, such as prevention of information leakage, detection of spoofing, and the like, a certificate is exchanged between the image forming apparatus 2 and each of the user terminals 4. That is, at the time of transmission of data from the user terminal 4 to the image forming apparatus 2, a certificate is transmitted. In addition, at the time of transmission of data from the image forming apparatus 2 to the user terminal 4, a certificate is transmitted. For example, upon request for execution of printing or execution of scanning, a certificate is transmitted from the user terminal 4. Authentication for the user is performed on the basis of the certificate, and a determination of permission or prohibition of connection, acquisition of authority information from the above-mentioned account management server, and the like are performed. Furthermore, for example, at the time of using a web service, a certificate is transmitted from the user terminal 4, and certification or encryption communication based on the certificate is performed. In order to perform detection of spoofing and data encryption, IPsec communication using a certificate is performed between the user terminal 4 and the image forming apparatus 2 that are connected to the second network. Furthermore, communication using a certificate is performed between the user terminal 4 and the image forming apparatus 2 that are peer-to-peer connected to each other.

As described above, the image forming apparatus 2 transmits and receives certificates. Since the image forming apparatus 2 includes plural communication interfaces (here, three communication interfaces, that is, the first network IF 2f, the second network IF 2g, and the third network IF 2i), certificates to be used (to be transmitted) by the individual communication interfaces need to be properly set.

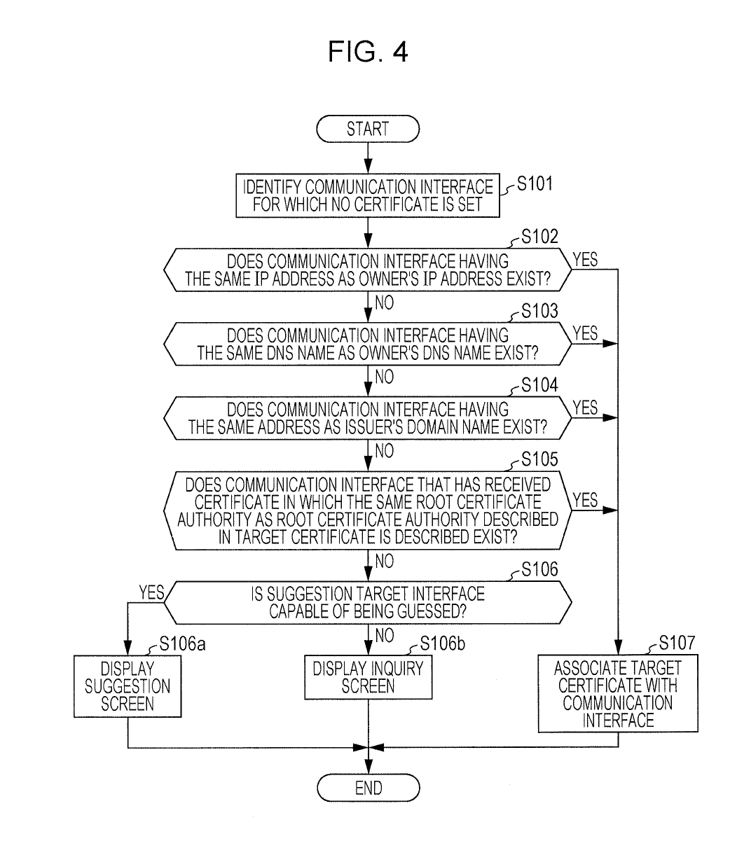

The image forming apparatus 2 performs a process exemplified by a flowchart of FIG. 4. In this exemplary embodiment, when the certificate A, the certificate B, and the certificate C are imported, the process illustrated in FIG. 4 is performed in accordance with an order for each of the certificates. Hereinafter, the process illustrated in FIG. 4 will be explained by representing a certificate to be processed as a target certificate (certificate information).

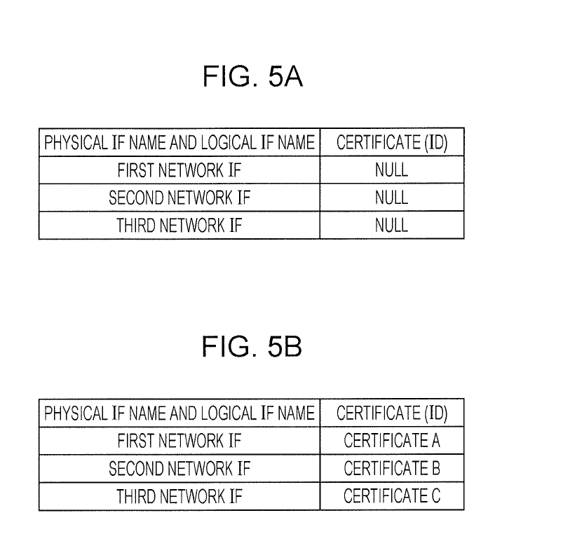

First, the controller 2a identifies, from among the first network IF 2f, the second network IF 2g, and the third network IF 2i, a communication interface for which no certificate is set (S101). In this exemplary embodiment, a certificate management table illustrated in FIG. 5A is stored in the hard disk 2c. In the certificate management table, as illustrated in FIG. 5A, in association with the physical interface name and logical interface name of a communication interface, the ID of a certificate set for the communication interface, that is, the ID of a certificate used by the communication interface, is stored. Since no certificate is set for each communication interface at the time immediately after importing is performed, no certificate ID is stored and “null” is set. A communication interface for which no certificate is set is identified by referring to such a certificate management table.

Then, the controller 2a (an identification information acquiring unit, a comparing part) reads the IP address (identification information) of the communication interface identified in S101, and determines whether or not the IP address is the same as the IP address of an owner described in a target certificate. Accordingly, the controller 2a determines whether or not a communication interface having the same IP address as the owner's IP address exists (S102). In the case where the owner's IP address is not described in the target certificate, the processing of S102 is skipped.

In the case where a communication interface having the same IP address as the owner's IP address exists (YES in S102), the controller 2a (an associating section, a determining unit) sets the target certificate for the communication interface having the same IP address as the owner's IP address (S107). More specifically, in the certificate management table (see FIG. 5A), the controller 2a associates the ID of the target certificate with the physical interface name and logical interface name of the communication interface having the same IP address as the owner's IP address. Then, the next certificate is set as a target certificate, and the process illustrated in FIG. 4 is performed.

In the case where no communication interface having the same IP address as the owner's IP address exists (NO in S102), the controller 2a (the identification information acquiring unit) reads the DNS name (identification information) of the communication interface identified in S101 from the IF management table. Then, the controller 2a (the comparing part) determines whether or not the DNS name is the same as the DNS name of the owner described in the target certificate. Accordingly, it is determined whether or not a communication interface having the same DNS name as the owner's DNS name exists (S103). In the case where no owner's DNS name is described in the target certificate, the processing of S103 is skipped.

In the case where a communication interface having the same DNS name as the owner's DNS name exists (YES in S103), the controller 2a performs processing of S107, in which the target certificate is set for the communication interface having the same DNS name as the owner's DNS name. In the case where no communication interface having the same DNS name as the owner's DNS name exists (NO in S103), the controller 2a (the comparing part) determines whether or not the domain name of an issuer described in the target certificate is the same as the address band of the IP address of the communication interface identified in S101. Accordingly, the controller 2a determines whether or not a communication interface having the same address band as the issuer's domain name exists (S104). In the case where no issuer's DNS name is described in the target certificate, the processing of S104 is skipped.

In the case where a communication interface having the same address band as the issuer's domain name exists (YES in S104), the controller 2a performs the processing of S107, in which the target certificate is set for the communication interface having the same address band as the issuer's domain name. In the case where no communication interface having the same address band as the issuer's domain name exists (NO in S104), the controller 2a (an acquiring unit) acquires, from the IF management table, history information on the history of communication performed by the communication interface identified in S101. In this exemplary embodiment, a certificate that a communication interface has received from the user terminal 4 is stored as history information in the IF management table. The controller 2a (a comparing part) determines whether or not a root certificate authority represented by certification path information in the history information is the same as a root certificate authority represented by certification path information in the target certificate. Accordingly, the controller 2a determines whether or not a communication interface that has received a certificate in which the same root certificate authority as the root certificate authority described in the target certificate is described exists (S105). Here, the controller 2a may determine in S105 whether or not a communication interface that has received a certificate in which the same intermediate certificate authority as the intermediate certificate authority described in the target certificate is described exists.

In the case where a communication interface that has never received a certificate from the user terminal 4 (hereinafter, noted as a non-reception interface) exists, that is, in the case where history information on a communication interface is not stored in the IF management table, the processing of S105 is skipped.

In the case where a communication interface that has received a certificate in which the same root certificate authority as the root certificate authority described in the target certificate is described exists (YES in S105), the controller 2a performs the processing of S107, in which the target certificate is set for the communication interface that has received the certificate in which the same root certificate authority as the root certificate authority described in the target certificate is described. In the case where no communication interface that has received a certificate in which the same root certificate authority as the root certificate authority described in the target certificate is described exists (NO in S105), the controller 2a performs specific processing for determining whether or not a communication interface to be suggested as a communication interface for which the target certificate is to be set (hereinafter, noted as a suggestion target interface) is capable of being guessed (S106). Then, the controller 2a performs outputting in accordance with a determination result.

That is, in the case where a suggestion target interface is capable of being guessed (YES in S106), the controller 2a displays on the display a suggestion screen for suggesting that the target certificate should be set for the suggestion target interface, by being triggered by execution of a so-called Push-system operation (an operation for causing the image forming apparatus 2 to transmit data) (S106a). In this case, an administrator of the image forming apparatus 2 manually sets the target certificate for the suggestion target interface.

In the case where a suggestion target interface is not capable of being guessed (NO in S106), the controller 2a displays on the display an inquiry screen for allowing the administrator of the image forming apparatus 2 to make an inquiry on a communication interface for which the target certificate is to be set, by being triggered by execution of a Push-system operation (S106b). In this case, the administrator of the image forming apparatus 2 sets the target certificate for a designated communication interface.

Accordingly, a certificate to be used by each communication interface is set. FIG. 5B illustrates an example of a certificate management table obtained after the process illustrated in FIG. 4 is performed. Referring to FIG. 5B, for execution of communication, the image forming apparatus 2 transmits, from the first network IF 2f, the certificate A set for the first network IF 2f. In addition, the image forming apparatus 2 transmits, from the second network IF 2g, the certificate B set for the second network IF 2g. In addition, the image forming apparatus 2 transmits, from the third network IF 2i, the certificate C from the third network IF 2i.

The invention is not limited to the exemplary embodiment described above.

For example, in the case where the above-mentioned non-reception interface exists and the processing of S105 is skipped, when a suggestion target interface is not capable of being guessed (NO in S106), the processing of S105 and S106 may be performed again after a specific period of time has passed. This is because the non-reception interface may receive a certificate from the user terminal 4 in the near future. However, in the case where the above-mentioned Push-system operation is performed before the specific period of time has passed, the processing of S105 and S106 is not performed again. Instead, the inquiry screen is displayed.

Furthermore, the present invention is applicable to any computer including plural communication interfaces as well as to an image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication apparatus comprising:
a plurality of communication interfaces;
an associating section that associates issued certificate information with one of the plurality of communication interfaces; and
a transmitting section that transmits the certificate information from the communication interface with which the certificate information is associated,
wherein the associating section includes
an identification information acquiring unit that acquires identification information in a network of each of the plurality of communication interfaces, and
a determining unit that determines a communication interface to be associated, in accordance with the identification information acquired by the identification information acquiring unit.

2. The communication apparatus according to claim 1, wherein the determining unit includes
a comparing part that compares the identification information acquired by the identification information acquiring unit with identification information in a network of an owner or an issuer, the identification information in the network of the owner or the issuer being described in the certificate information, and
a determining part that determines a communication interface to be associated, in accordance with a result of the comparison by the comparing part.

3. A communication apparatus comprising:
a plurality of communication interfaces;
an associating section that associates issued certificate information with one of the plurality of communication interfaces; and
a transmitting section that transmits the certificate information from the communication interface with which the certificate information is associated,
wherein the associating section includes
an acquiring unit that acquires certificate information that each of the plurality of communication interfaces received from a different apparatus, and
a determining unit that determines a communication interface to be associated, in accordance with the certificate information acquired by the acquiring unit.

4. The communication apparatus according to claim 3, wherein the determining unit includes
a comparing part that compares a certificate authority identified in accordance with certificate information acquired by the acquiring unit with a certificate authority identified in accordance with the issued certificate information, and
a determining part that determines a communication interface to be associated, in accordance with a result of the comparison by the comparing part.

5. A communication method comprising:
associating issued certificate information with one of a plurality of communication interfaces; and
transmitting the certificate information from the communication interface with which the certificate information is associated,
wherein the associating includes
acquiring identification information in a network of each of the plurality of communication interfaces, and
determining a communication interface to be associated, in accordance with the acquired identification information.

6. A computer readable medium storing a program causing a computer to execute a process for communication, the process comprising:
associating issued certificate information with one of a plurality of communication interfaces; and
transmitting the certificate information from the communication interface with which the certificate information is associated,
wherein the associating includes
acquiring identification information in a network of each of the plurality of communication interfaces, and
determining a communication interface to be associated, in accordance with the acquired identification information.

7. A computer readable medium storing a program causing a computer to execute a process for communication, the process comprising:
associating issued certificate information with one of a plurality of communication interfaces; and
transmitting the certificate information from the communication interface with which the certificate information is associated,
wherein the associating includes
acquiring certificate information that each of the plurality of communication interfaces received from a different apparatus, and
determining a communication interface to be associated, in accordance with the acquired certificate information.
